(19) United States
(12) Patent Application Publication
(10) Pub. No.: US 2015/0058339 A1
(43) Pub. Date: Feb. 26, 2015

(54) METHOD FOR AUTOMATING SEARCH ENGINE OPTIMIZATION FOR WEBSITES

(71) Applicant: Go DaddyOperating Company, LLC, Scottsdale, AZ (US)

(72) Inventors: Rajinder Nijjer, Phoenix, AZ (US); Jim Christian, Scottsdale, AZ (US)

(73) Assignee: Go DaddyOperating Company, LLC, Scottsdale, AZ (US)

(21) Appl. No.: 14/010,294

(22) Filed: Aug. 26, 2013

(51) Int. Cl. G06F 17/30

(52) U.S. Cl. CPC G06F 17/30864
USPC 707/736

(57) ABSTRACT

Systems and methods for automating search engine optimization of a website may include obtaining a set of keywords using a computer network. The keywords may be relevant to a business and may be obtained from the website of identified local competitors to the business. The system may present the keywords to the user in a display and provide an interface with an option to refine the set of keywords. The system may include in the display one or more educational displays to help the user choose appropriate keywords from the keyword set. The system may create a website for the business, including inserting the keywords into one or more web pages of the website. Inserting the keywords may include adding HTML to the web pages and identifying focus keywords and a primary location to one or more search engines.

### CROSS-REFERENCE TO RELATED APPLICATIONS

Not applicable.

### FIELD OF THE INVENTION

The present invention generally relates to website design and communication, and, more specifically, to systems and methods for efficiently and effectively generating a website that is optimized for achieving a high relative placement in Internet search results.

### BACKGROUND OF THE INVENTION

The Internet comprises a vast number of computers and computer networks that are interconnected through communication links. The interconnected computers exchange information using various services. In particular, a server computer system, referred to herein as a web server, may connect through the Internet to a remote client computer system and may send, to the remote client computer system upon request, one or more websites containing one or more graphical and textual web pages of information. A request is made to the web server by visiting the website's address, known as a Uniform Resource Locator (“URL”). Upon receipt, the requesting device can display the web pages. The request and display of the websites are typically conducted using a browser. A browser is a special-purpose application program that effects the requesting of web pages and the displaying of web pages.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A URL is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows an Internet user to use an ICANN-accredited registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's webpage and typing the desired domain name into a field on the registrar's webpage created for this purpose. Upon receiving the request from the Internet user, the registrar may ascertain whether “mycompany.com” has already been registered by checking the SRS database associated with the TLD of the domain name. The results of the search then may be displayed on the webpage to thereby notify the Internet user of the availability of the domain name. If the domain name is available, the Internet user may proceed with the registration process. Otherwise, the Internet user may keep selecting alternative domain names until an available domain name is found. Domain names are typically registered for a period of one to ten years with first rights to continually re-register the domain name.

The information on web pages is in the form of programmed source code that the browser interprets to determine what to display on the requesting device. The source code may include document formats, objects, parameters, positioning instructions, and other code that is defined in one or more web programming or markup languages. One web programming language is HyperText Markup Language (“HTML”), and all web pages use it to some extent. HTML uses text indicators called tags to provide interpretation instructions to the browser. The tags specify the composition of design elements such as text, images, shapes, hyperlinks to other web pages, programming objects such as JAVA applets, form fields, tables, and other elements. The web page can be formatted for proper display on computer systems with widely varying display parameters, due to differences in screen size, resolution, processing power, and maximum download speeds.

For Internet users and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other. Competition between business has increased, as more businesses can access the same customers electronically. That is, a local business does not only compete with its “brick-and-mortar” physical neighbors, but also with businesses in distant locations and businesses that interact with customers purely online.

Customers frequently use Internet search engines, such as GOOGLE, BING, YAHOO, or BAIDU, to find businesses that provide the goods or services sought. The customer enters keywords relevant to the goods or services into the search engine and receive search engine results pages (“SERPs”) displaying websites or web pages in order of relevance to the entered keywords. In order to attract customers online, a business benefits from its website placing highly on SERPs for keywords that are relevant to its business. To improve its placement, a business may engage in search engine optimization (“SEO”) of its website. SEO may include modifying the code of web pages in the business's website to include strategically selected keywords in particular parts of the web pages. However, due to the volume of businesses having an Internet presence, a business may have difficulty identifying and implementing the most effective keywords for improving its SERP placement.

### BRIEF DESCRIPTION OF THE DRAWINGS

FIG. 1 is schematic diagram of a system and associated operating environment in accordance with the present disclosure.

FIG. 2 is a flow diagram of a first embodiment of a method for automating search engine optimization of a website in accordance with the present disclosure.

FIG. 3 is a screenshot diagram of using an interface to display a keyword set with analytical data.

FIG. 4 is a screenshot diagram of using an interface to display a keyword set with analytical data and competitive use data.

FIG. 5 is a screenshot diagram of a ranking report.

FIG. 6 is a flow diagram of a second embodiment of a method for automating search engine optimization of a website in accordance with the present disclosure.

FIGS. 7-9 are screenshot diagrams of using an interface to collect business information.

FIG. 10 is a screenshot diagram using an interface to collect competitor information.

FIG. 11 is a screenshot diagram of using an interface to present a keyword set for refinement.

FIG. 12 is a screenshot diagram of using an interface to select a focus keyword.

FIG. 13 is a screenshot diagram of using an interface to set the business primary location.

FIGS. 14-17 are screenshot diagrams of using an interface to insert keywords into web page code.

FIG. 18 is a block diagram showing the functional components of a system for automating search engine optimization of a website according to the present disclosure.

### DETAILED DESCRIPTION OF THE PREFERRED EMBODIMENT

The present invention overcomes the aforementioned drawbacks by providing a system and method for the creation of a website by automatically retrieving a set of potentially relevant keywords for the user's website, such as from one or more local competitors' websites, and collecting additional data to assist the user in selecting the keywords to use for SEO of its website. The web server tasked with serving the website to requesting devices, also known as a hosting provider, may perform one or more algorithms for the website SEO, and may further perform one or more algorithms for the website creation. Alternatively, the web server may assign the SEO and website creation to a related computer system, such as another web server, collection of web or other servers, a dedicated data processing computer, or another computer capable of performing the creation algorithms. Alternatively, a standalone program may be delivered to and installed on a personal computing device, such as the user's desktop computer or mobile device, and the standalone program may be configured to cause the personal computing device to perform the algorithms. For clarity of explanation, and not to limit the implementation of the present methods, the methods are described below as being performed by a web server that serves the web page to requesting devices.

In one implementation, a method in accordance with the disclosure may include obtaining, by at least one computer server, a set of keywords using a computer network. The one or more keywords may be relevant to a business. The method may further include presenting to the user, by the at least one computer server, a first display containing a plurality of the keywords in the set of keywords and an interface with an option to refine the set of keywords on the first server. The method may further include receiving, by the at least one computer server, a refined set of keywords from the user, creating, by the at least one computer server, a website for the business, and inserting, by the at least one computer server, keywords from the refined set of keywords into one or more web pages of the website.

In another implementation, a system in accordance with the disclosure may include a server in electronic communication with the Internet, with a user, and with one or more data stores. The server may be configured to create a website for the user by obtaining a set of one or more keywords. The server may obtain the set of keywords by visiting one or more local competitor websites, identifying, from keywords being used on each of the local competitors websites, one or more potentially relevant keywords for the user, and compiling the set of keywords from the potentially relevant keywords. The server may be further configured to retrieve analytical data for each keyword in the set from one or more of the data stores, to present to the user a display and an interface that together enable the user to review the set and the analytical data and increase or decrease the number of keywords in the set, and to insert the keywords from the set into one or more web pages of the website.

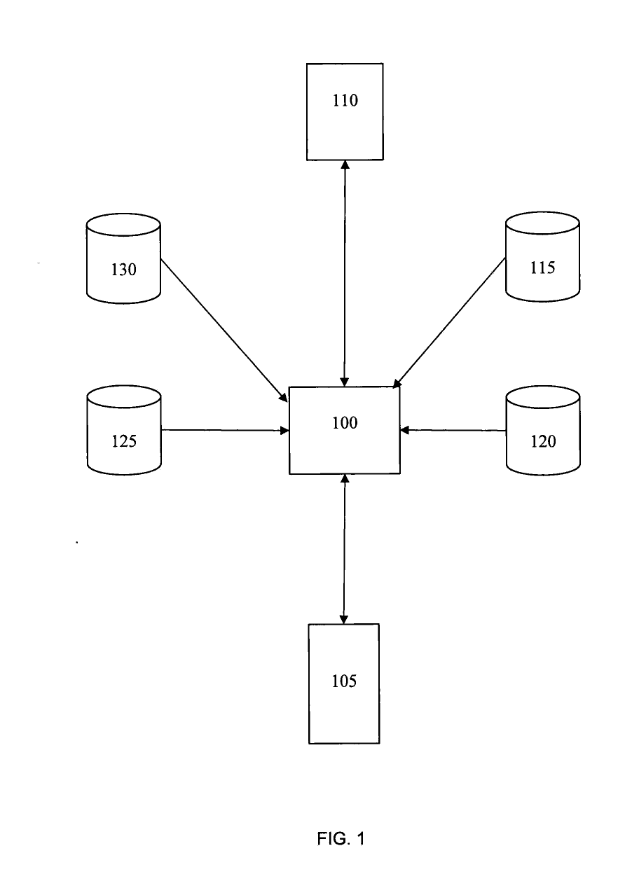

Referring to FIG. 1, a web server 100 may be configured to communicate over the Internet with one or more requesting devices 110 in order to serve requested website content to the requesting device 110. The requesting devices 110 may request the website content using any electronic communication medium, communication protocol, and computer software suitable for transmission of data over the Internet. Examples include, respectively and without limitation: a wired connection, WiFi or other wireless network, cellular network, or satellite network; Transmission Control Protocol and Internet Protocol (“TCP/IP”), Global System for mobile Communications (“GSM”) protocols, code division multiple access (“CDMA”) protocols, and Long Term Evolution (“LIE”) mobile phone protocols; and web browsers such as MICROSOFT INTERNET EXPLORER, MOZILLA FIREFOX, and APPLE SAFARI.

The web server 100 may be configured to create or modify a website that can be requested by and displayed on requesting devices 110. In some embodiments, such creation may include generating a plurality of versions of the website that convey substantially the same content but are particularly formatted to be displayed on certain requesting devices 110 or in certain browsers. For example, the web server 100 may generate a first version of the website that is formatted for PCs, and a second version of the website that is formatted for display on mobile phones. In other embodiments, such creation may include converting a website from a format that can be displayed on one type of requesting device 110 into a website that can be displayed on another type of requesting device 110. For example, the web server 100 may, upon receiving a request for the website from a mobile phone, convert the website designed to be displayed on a PC into a format that can be displayed on the mobile phone. In the present disclosure, therefore, the term website refers to any web property communicable via the Internet, such as websites, mobile websites, web pages within a larger website (e.g. profile pages on a social networking website), vertical information portals, distributed applications, and other organized data sources accessible by any device that may request data from a storage device (e.g., a client device in a client-server architecture), via a wired or wireless network connection, including, but not limited to, a desktop computer, mobile computer, telephone, or other wireless mobile device.

The web server 100 may be configured to communicate electronically with one or more data stores in order to retrieve information from the data stores. The electronic communication may be over the Internet using any suitable electronic communication medium, communication protocol, and computer software including, without limitation: a wired connection, WiFi or other wireless network, cellular network, or satellite network; TCP/IP or another open or encrypted protocol; browser software, application programming interfaces, middleware, or dedicated software programs. The electronic communication may be over another type of network, such as an intranet or virtual private network, or may be via direct wired communication interfaces or any other suitable interface for transmitting data electronically from a data store to the web server 100. In some embodiments, a data store may be a component of the web server 100, such as by being contained in a memory module or on a disk drive of the web server 100.

A data store may be any repository of information that is or can be made freely or securely accessible by the web server 100. Suitable data stores include, without limitation: databases or database systems, which may be a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future; file systems; and electronic files such as web pages, spreadsheets, and documents. Each data store accessible by the web server 100 may contain information that is relevant to the creation, modification, or SEO optimization of the website, as described below. Such data stores include, without limitation to the illustrated examples: search engines 115; website information databases 120, such as domain registries, hosting service provider databases, website customer databases, and Internet aggregation databases such as archive.org; business listing data stores 125, such as YELP!, Yellow Pages, GOOGLE PLACES, LOCU, and the like; and Internet traffic databases 130 as described below.

To create or modify its website, a user may access the web server 100 with the user's device 105, which may be a PC, a mobile device, or another device able to connect electronically to the web server 100 over the Internet or another computer network. The user may be an individual, a group of individuals, a business or other organization, or any other entity that desires to publish a website that conveys information about the user or another topic, where the information may be of a commercial or a non-commercial nature, and where the website is configured to maximize its own prominence within search results for certain words related to the content of the website. For clarity of explanation, and not to limit the implementation of the present methods, the methods are described below as being performed by a web server that receives input for creating a website for a small business, such as a restaurant or bar, retail store, or service provider (e.g. barber shop, real estate or insurance agent, repair shop, equipment renter, and the like), unless otherwise indicated.

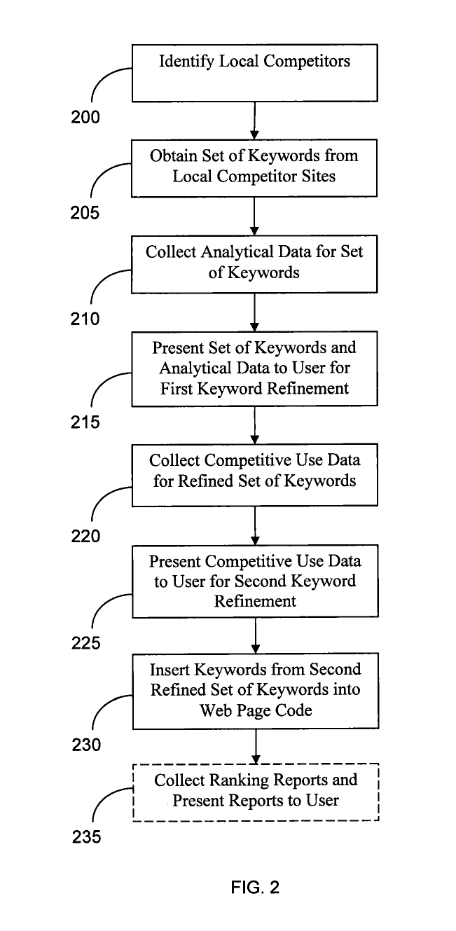

Referring to FIG. 2, the web server 100 may perform a method of partially or fully automating SEO of a user's website, either in conjunction with generating the website, so that the website may be activated with a SEO strategy in place, or as a subsequent optimization step if the website has already been created. In the illustrated method and other methods according to this disclosure, SEO includes identifying one or more valuable keywords and incorporating the keywords into the user's website. A keyword's value derives from its relevance to goods, services, or content offered for sale or otherwise provided by the user, such that the user desires its website to place highly on SERPs for searches that include the keyword.

In some embodiments, SEO optimization may include determining the common or high-traffic keywords being used on the websites of the user's competitors, in order to either use or avoid those keywords. At step 200, the web server 100 may identify one or more local competitors to the user's business. The local competitors may be identified by receiving identifying information, such as a competing business name, from the user. The local competitors may further or alternatively be identified using one or more Internet searches. For example, the user may provide or the web server 100 may otherwise obtain one or more suitable categories of the business (e.g. restaurant, repair shop, pet store), and the web server 100 may identify local competitors by searching one or more data stores using the category and a local area identifier, such as a city name or zip code, as search terms. The web server 100 may identify the local competitors from the search results of one or more of the searched data stores, which may include Internet search engines, business listing services (e.g. YELP, GOOGLE PLACES), local listing services, and the like.

At step 205, the web server 100 may compile a set of potentially relevant keywords by obtaining one or more keywords from one or more websites of identified local competitors and adding the keywords to the set. The web server 100 may use any suitable web crawling, spidering, or scraping methodology, or a combination of such methodologies, to evaluate the content of each of the local competitors' websites. The web server 100 may review web page source code, including HTML, CSS, readable scripting languages, Microdata, and other page text. The web server 100 may identify, as potentially relevant keywords, the keywords being used on the web pages, by scraping the words contained within HTML tags that typically contain keywords, such as the page <title> or one or more <meta> or <header> tags. The web server 100 may perform text and context analysis upon images, web applications, and other web page elements, in order to extract one or more keywords. Text analysis may include optical character recognition (“OCR”) or other text-identifying techniques, which extract words from the photograph. Context analysis may include relative comparison of identified text, such as text size and placement on a photographed sign, in order to identify relative importance of extracted keywords. In some embodiments, the web server 100 may transcribe an audio recording and perform pattern analysis on the transcription, the recording, or both. The web server 100 may identify heavily repeated words or words that are relatively heavily inflected as keywords. The web server 100 may further obtain potentially relevant keywords through usage analysis. Non-limiting examples of usage analysis include calculating the frequency or density of a word's appearance on the web page or throughout the website, and searching alternate text tags for prominent images on the web pages.

At step 210, the web server 100 may collect analytical data for the set of potentially relevant keywords. The web server 100 may access one or more data stores containing website traffic data. Accessing the data stores may include communicating with an analytical interface, such as the Keyword Tool interface provided by GOGGLE ADWORDS. Such an interface may automatically retrieve traffic data from the relevant data stores according to a query submitted by the web server 100. A query may include one or more of the set of keywords and an indication of the desired traffic data. The desired traffic data for a keyword may be any data pertaining to how extensively Internet users use the keyword to find content relevant to the keyword in the Internet. Such traffic data may include the number of searches performed that include the keyword. The data pertaining to number of searches may be limited or divided according to a set period (e.g. monthly searches, or a monthly average over 12 months), a geographical area (e.g. frequency of global, regional, or local searches), or other suitable parameters. The desired traffic data may further include competitiveness data, which may indicate the number of advertisers in an advertising network, such as ADWORDS, that are paying for favored placement in SERPs for that keyword. The desired traffic data may further include suggested related keywords and the number of searches and competitiveness data for each of the suggested related keywords. In other embodiments, such as when the data stores containing the traffic data are located on the web server 100, the web server 100 may submit queries directly to the data stores rather than through a third-party or otherwise separate analytical interface.

The web server's 100 query may include limiting parameters for narrowing retrieved traffic data. One such parameter may be a match flag for indicating that only traffic data for searches containing the exact keyword supplied by the web server 100 should be returned. Limiting by exact match may prevent broad results and correspondingly inflated traffic data. Another parameter may be precise geographic localization, such as by providing the IP address or GPS location of the user, which may improve the accuracy of results deemed “local” to the user by the web server 100 or analytical interface. Another parameter may be limiting traffic data to a user-provided radius around the user's business, within which the user serves its customers, such as when a burrito maker only delivers in a five-mile radius of his hut.

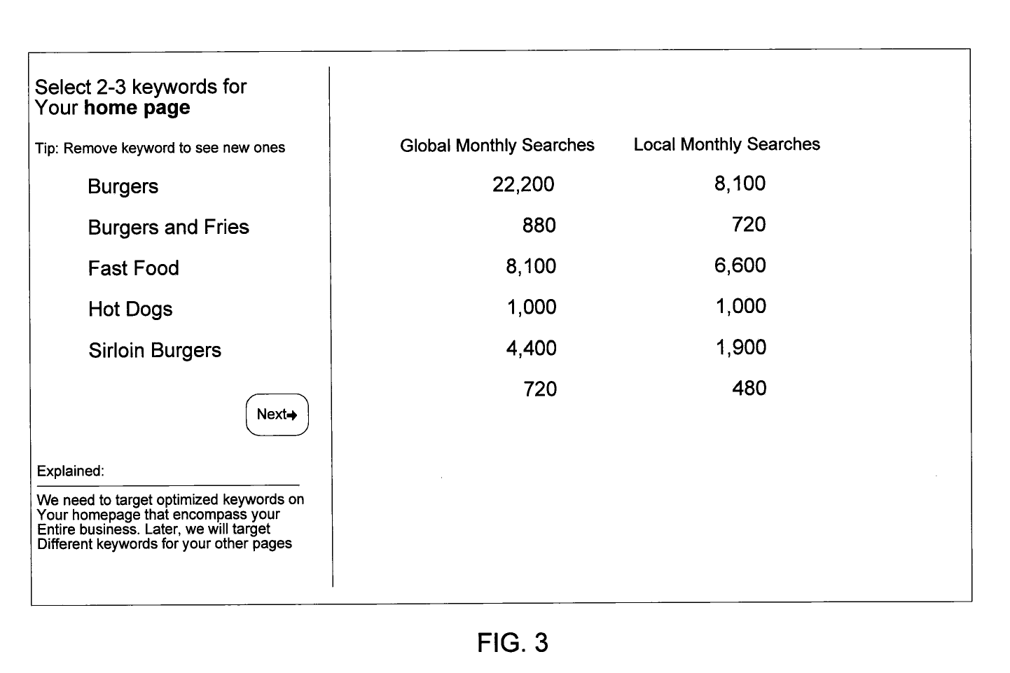

At step 215, the web server 100 may present the set of keywords and associated retrieved traffic data to the user and provide to the user the option to refine the set by adding or removing keywords as desired. Referring to FIG. 3, presenting the set of keywords may include displaying to the user a list 300 of the keywords in the set, along with one or more elements of the traffic data collected at step 210. Presenting the set of keywords may include providing one or more educational displays 305 for helping less experienced users implement an effective keyword-based SEO strategy. For example, the educational displays 305 may inform the user that a suitable keyword set includes 5-10 interrelated keywords per page, where less than five keywords does not provide sufficient coverage of the relevant subject matter, and more than ten keywords or inclusion of unrelated keywords may cause search indexes to ignore the keywords or penalize the web pages in their rankings due to inappropriate “keyword stuffing” on the pages.

The web server 100 may provide an interface to the user to refine the set of keywords. The user may choose to remove any keywords in the set that the user determines are irrelevant or have low relevance, have a low search volume or a high level of competition, are overly generic, or have some other undesirable characteristic. The user may choose to add keywords by manually adding keywords the user wants to use that are not in the set. The user may additionally or alternatively add keywords by requesting additional keywords from the web server 100. In response to such a request, the web server 100 may provide additional keywords, which may be obtained from the keywords suggested by the analytical interface or by again scraping one or more of the identified competitors' websites. The web server 100 may collect analytical data as in step 210 for any added keyword.

At step 220, the web server 100 may collect competitive use data for the keywords in the set as refined by the user in step 215. The competitive use data may include the total number of competitors, as reflected by usage of the keywords on the competitors' websites. The competitive use data may further include data specific to one or more competitors, such as business listing data including the business category, services or goods offered, keywords used and rank in SERPs. Collecting the competitive use data may include performing one or more keyword-based Internet searches to ascertain the total number of websites that have the keyword at one or more relevant locations on the website. In one embodiment, a substantially accurate total number of websites using the keyword as an indicator of goods or services offered may be obtained as the number of search results for a search limited to websites containing the keyword within both its HTML <title> tag and within its “backlinks,” which are textual links to the website from other websites.

The competitive use data may further include one or more additional SEO metrics for each competitor's website that may indicate size, online influence, or degree of penetration for some or all keywords. Such SEO metrics may include, without limitation, ranking strengths such as Page Authority or Domain Authority as calculated by SEOMOZ, social use data, such as the appearance of the keyword in one or more competitors' social media signals such as TWITTER postings, FACEBOOK “likes” and “shares,” and other metrics. Where included SEO metrics are calculated by third parties, such as is the case for a Domain Authority score, the web server 100 may maintain access to the SEO metrics through an application programming interface (“API”) with the third party and may retrieve the SEO metric from the third party in step 220.

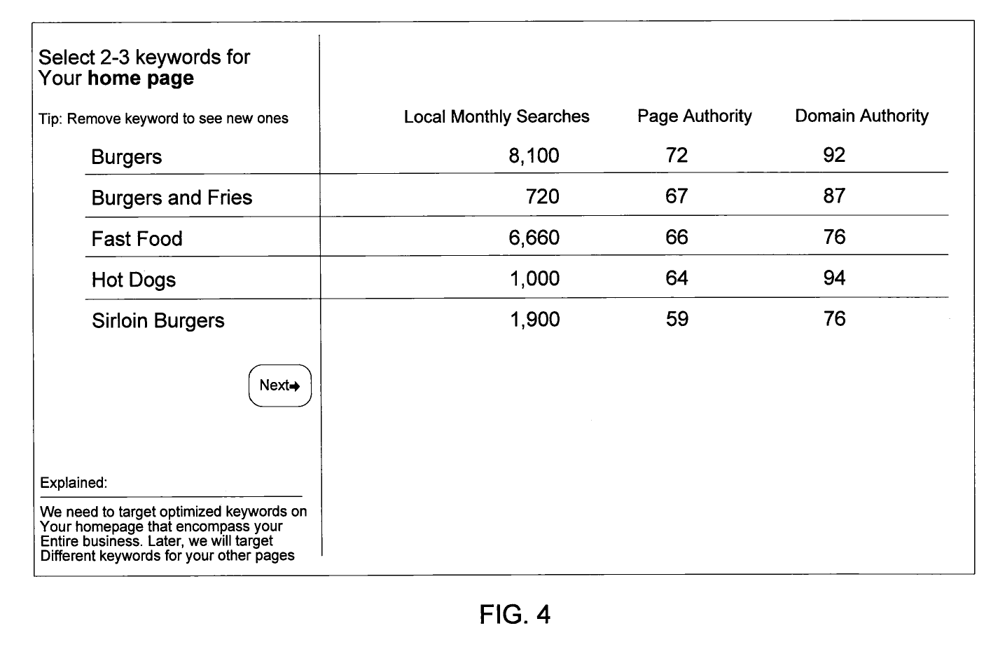

At step 225, the web server 100 may incorporate the competitive use data into a display of the refined set of keywords and present the display to the user for further refinement of the keyword set. See FIG. 4. In this second keyword refinement, the user may reduce the total number of keywords in the set. The web server 100 may use the user's refinement choices to present or remove additional keywords in any number of subsequent refinements until the keyword set contains the desired keywords.

At step 230, the web server 100 may insert the keywords from the refined set of keywords into the source code of one or more web pages in the user's website. Insertion of the keywords may include generating (or modifying if the web page was previously generated) HTML elements that contain one or more of the keywords in the set. In some embodiments, the HTML elements may be tagged elements such as the <title> element and <meta name=“description” . . . > element. The web server 100 may finish creating and then publish the website once the keywords are added.

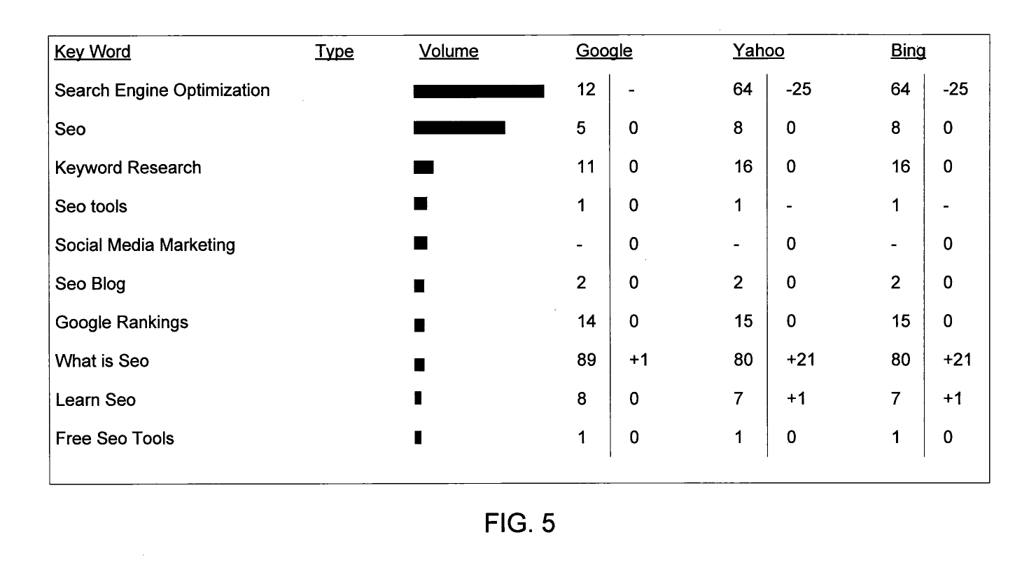

At step 235, the web server 100 may collect one or more ranking reports and present the reports to the user as a form of validation to the user that the SEO optimization is performing as intended. This step is optional and may be performed a suitable amount of time after the website has been published, so that data pertaining to SERP placement and customer visits can be collected for creating the ranking reports. Referring to FIG. 5, a ranking report 350 may explain the current position of the user's website in SERPs for the keywords from the keyword set derived by the web server 100. The ranking report may compare the current position to previous positions, as well as to positions of the user's competitors, to illustrate upward progress through the rankings for each keyword.

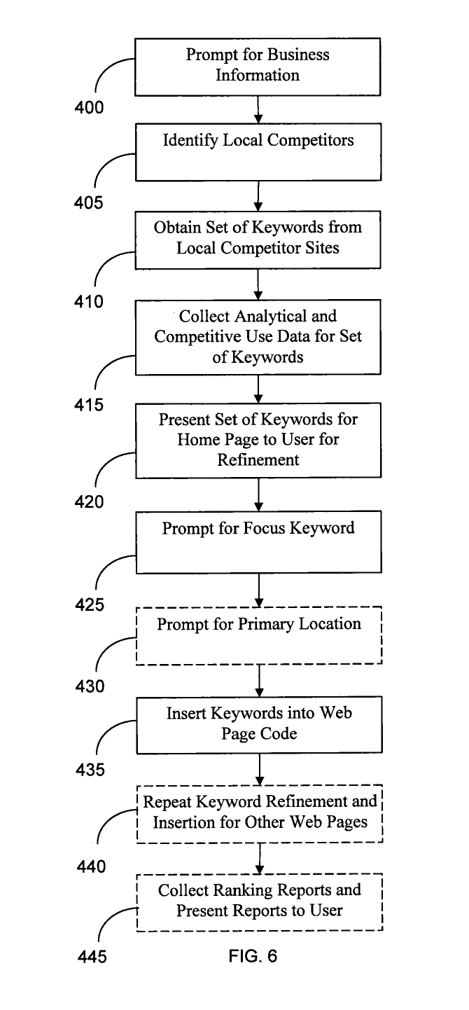

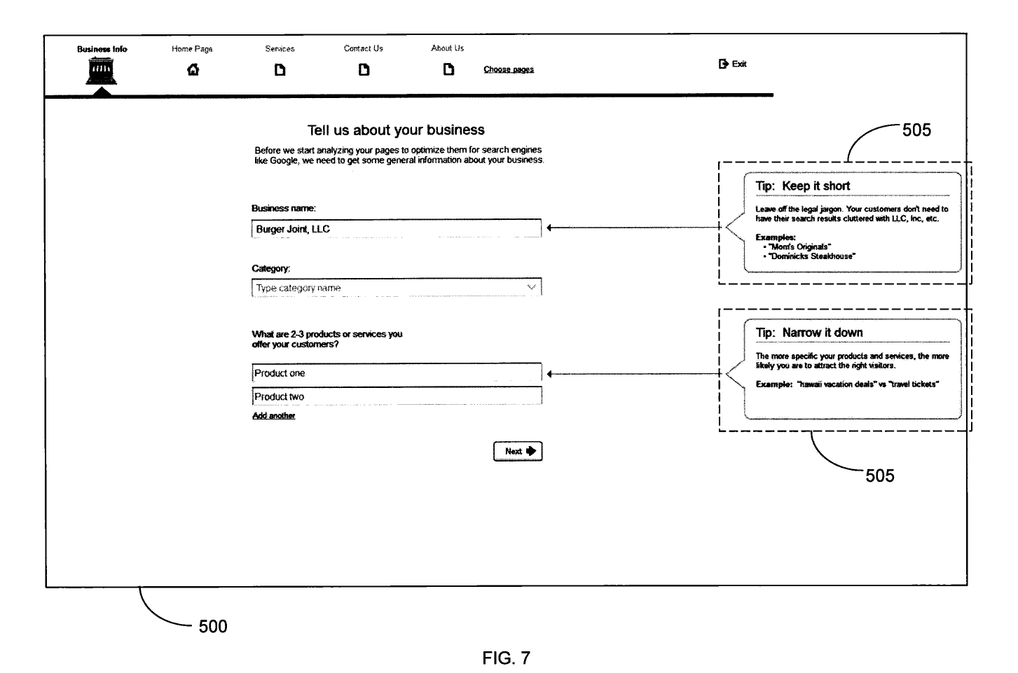

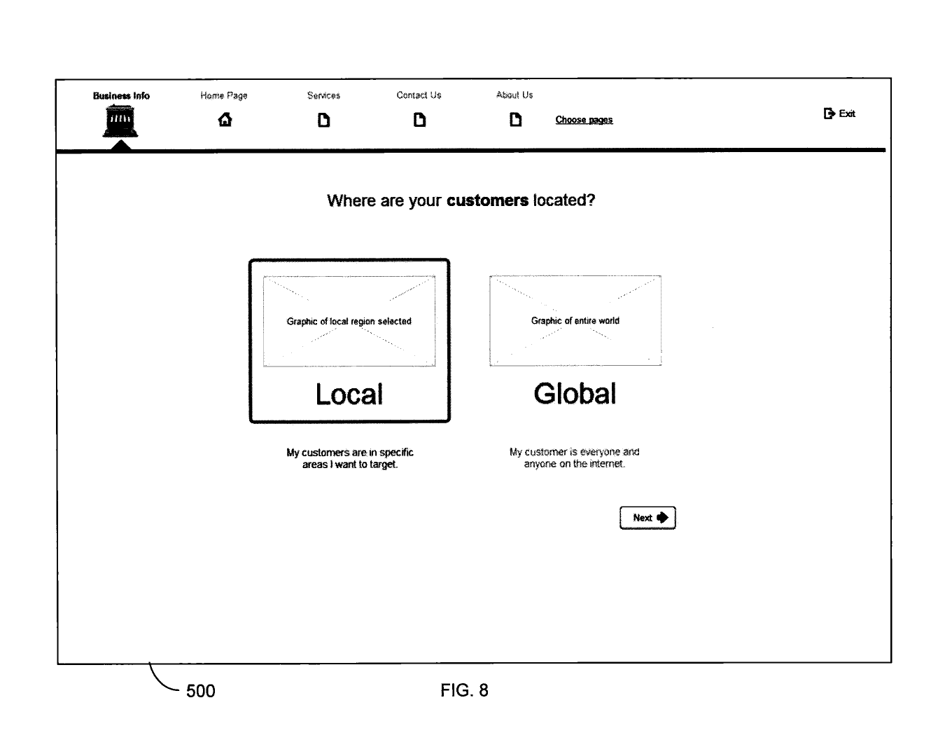

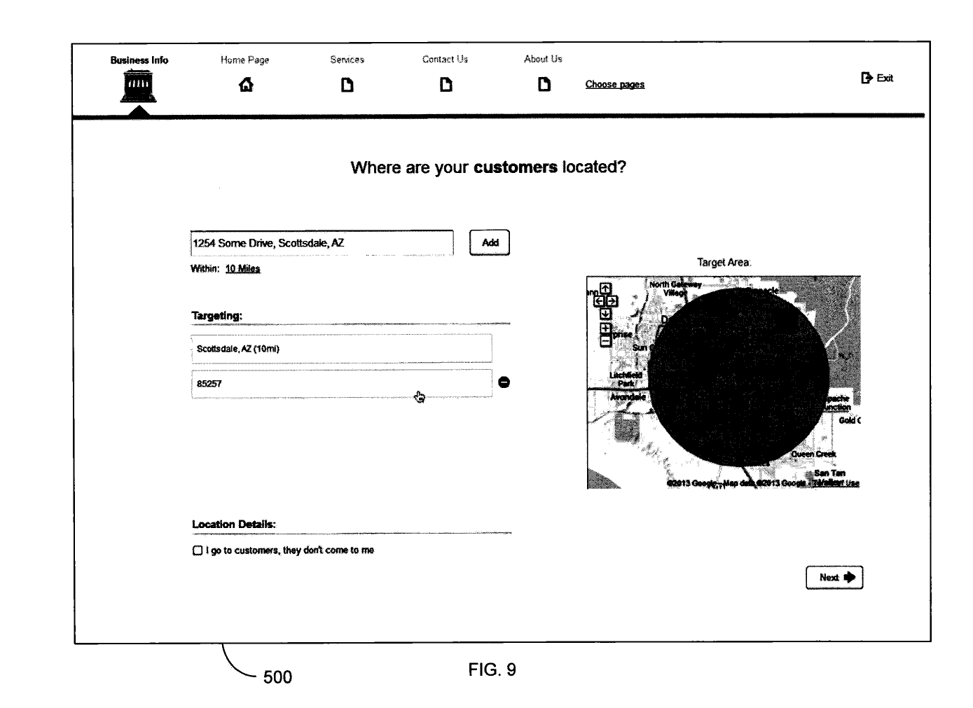

FIG. 6 illustrates another embodiment of a method of performing automatic SEO for a website as a component of a website building process, while FIGS. 7-17 illustrate a web-based interface 500 for implementing the method of FIG. 6. The interface may include one or more educational displays 505 for helping the user supply SEO-friendly input at the prompts. At step 400, the web server 100 may prompt the user to enter one or more identifying elements of business information. The business information may include, without limitation and with reference to FIGS. 7-9: the business name; the category or type of business (e.g. restaurant, bicycle shop, aerospace engineering firm), which may be selected from a drop-down menu of pre-populated common categories or typed by the user; one or more descriptive words for goods or services offered; customer localization information, such as an indication of whether the business' customers are global (i.e. any Internet user) or non-global (i.e. local or regional customers), and further targeting of a specific locale, such as a radius around the business' physical location (see FIG. 9); and other information that may inform the web server's 100 execution of subsequent steps.

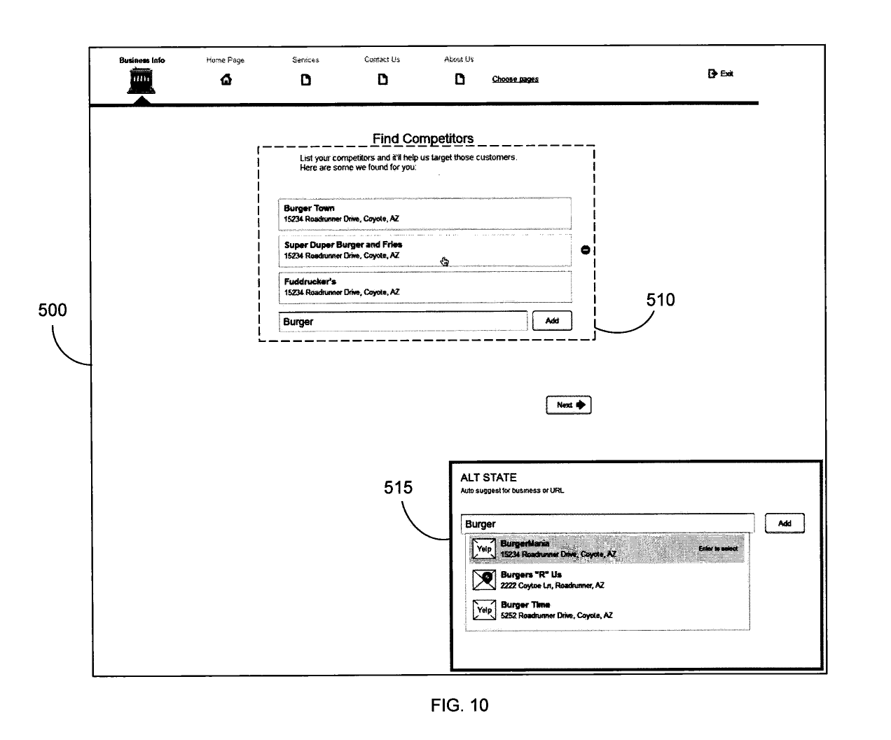

At step 405, the web server 100 may identify local competitors to the user's business, as described above with respect to step 200 of FIG. 2. FIG. 10 illustrates a results display 510 that lists local competitors identified by the web server 100 by searching one or more data stores using one or more of the identifying elements of the business information provided by the user at step 400. The user may select or remove any local competitor from the display 510. FIG. 10 further illustrates an alternative local competitor search 515, wherein the user supplies all or part of the business name. The web server 100 can auto-suggest businesses based on the user's input.

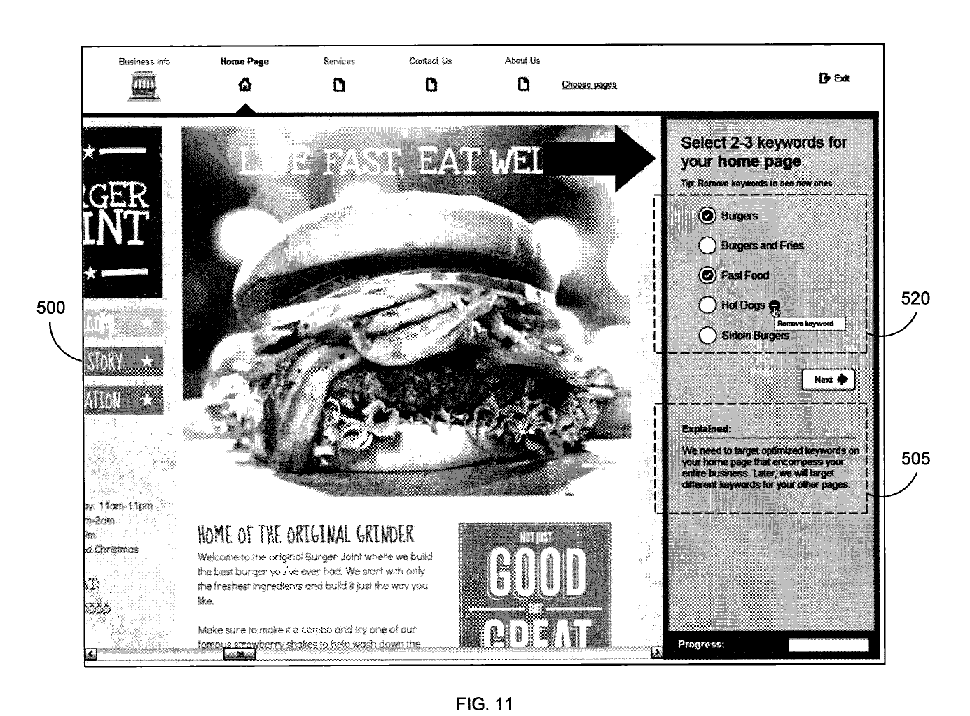

At step 410, the web server 100 may obtain a set of keywords from the websites of identified local competitors, as described above with respect to step 205 of FIG. 2. At step 415, the web server 100 may collect analytical data and competitive use data for the keywords in the set, as described above with respect to steps 210 and 220 of FIG. 2. At step 420, the web server 100 may present the set of keywords to the user for a first refinement. The first refinement may have the goal, explained to the user with educational displays 505, of selecting a limited number of keywords to be used on the “home” web page of the user's website. The web server 100 may employ an iterative process to narrow the set of keywords down to a home page set containing the desired number of keywords. Referring to FIG. 11, the iterative process may include presenting a subset 520 of the set of keywords and allowing the user to select the keywords to keep and delete the keywords to remove from the set, replacing the removed keywords with additional keywords from the set until the desired number of keywords is selected.

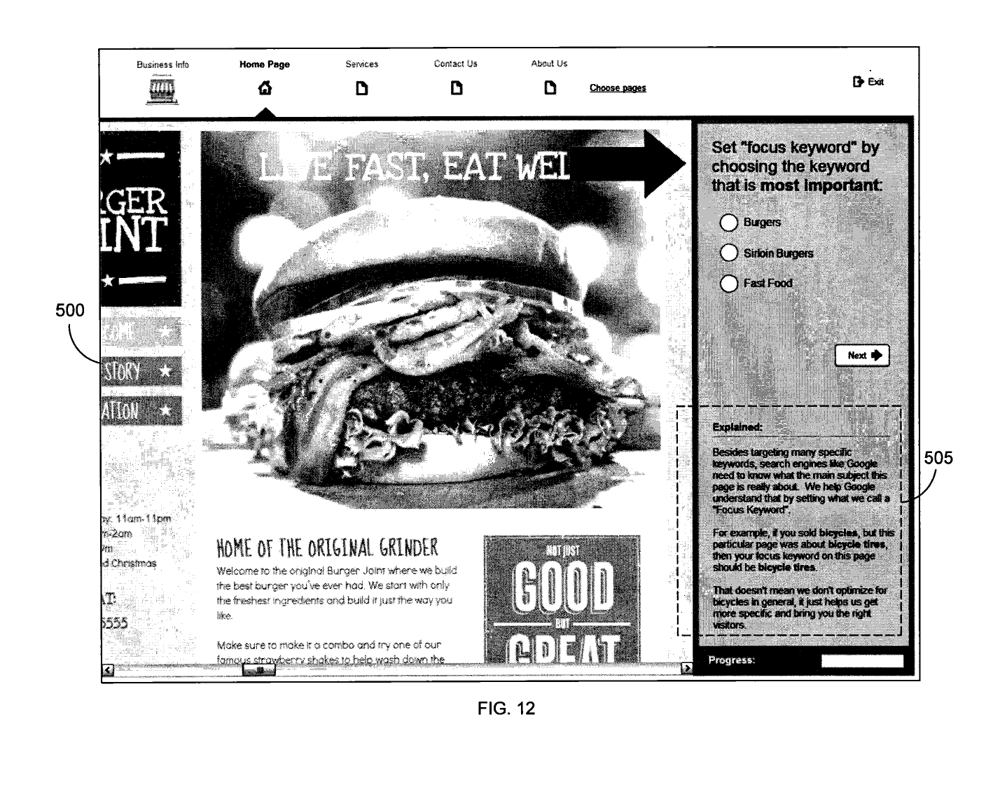

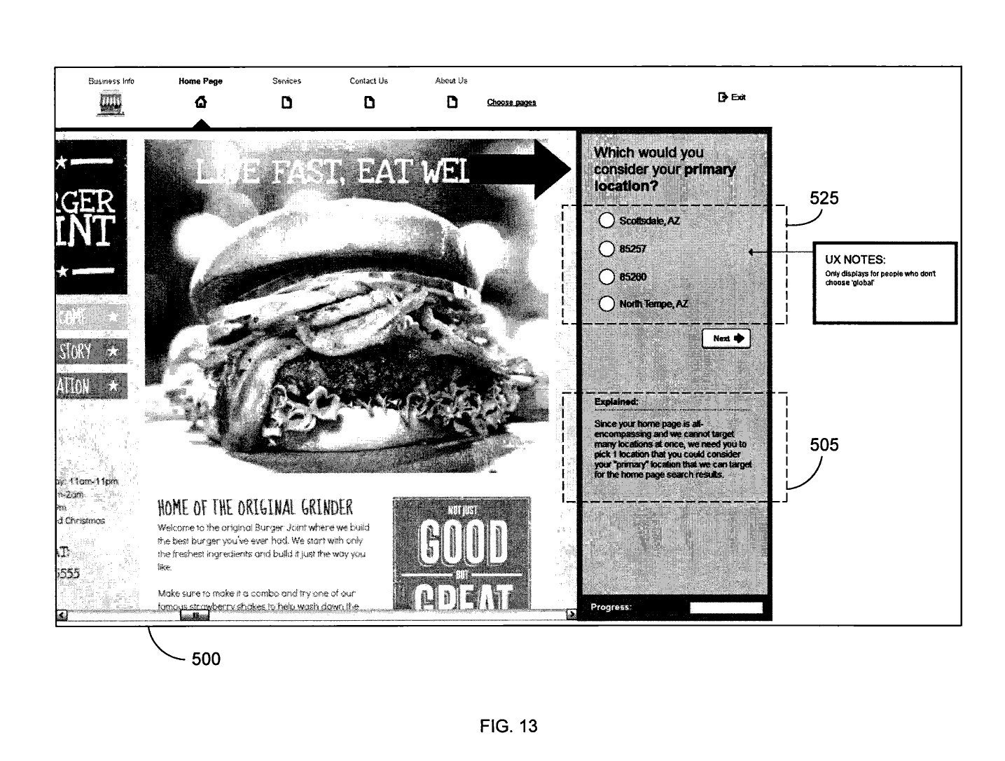

At step 425, the web server 100 may prompt the user to select a focus keyword from the home page set of selected keywords. See FIG. 12. The focus keyword is used by Internet search engines to determine the main subject of the web page on which it appears, and therefore should be the keyword that the user considers to be most relevant to the content of the web page. At step 430, if the user has indicated that its customers are non-global (i.e. localized or regionalized), the web server 100 may prompt the user to set a primary location. See FIG. 13. The primary location may be used by the web server 100 to inform Internet search engines of the business' location so that search results may be focused within the locale of the primary location. A list 525 of potential primary locations may include the city, a relevant part of the city, a zipcode, or other geographic indicators of the primary location.

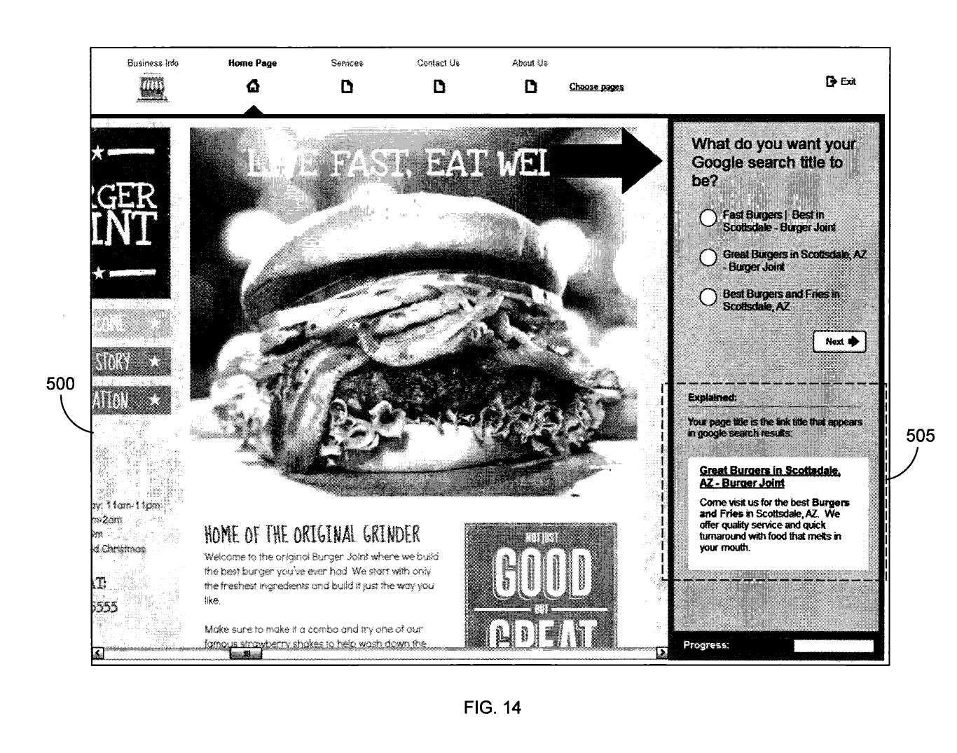

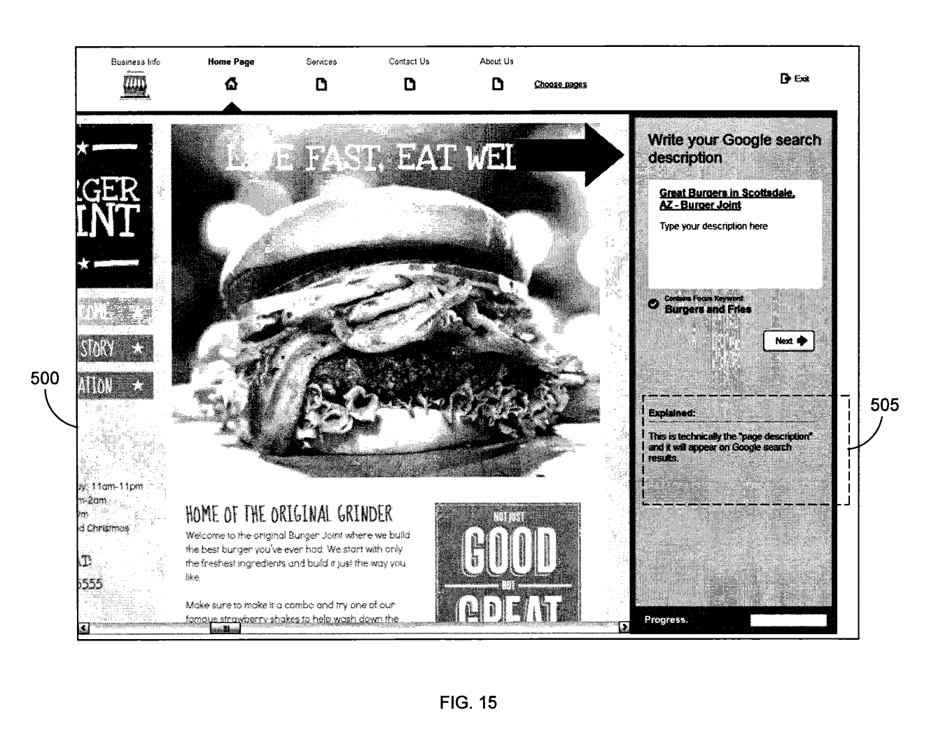

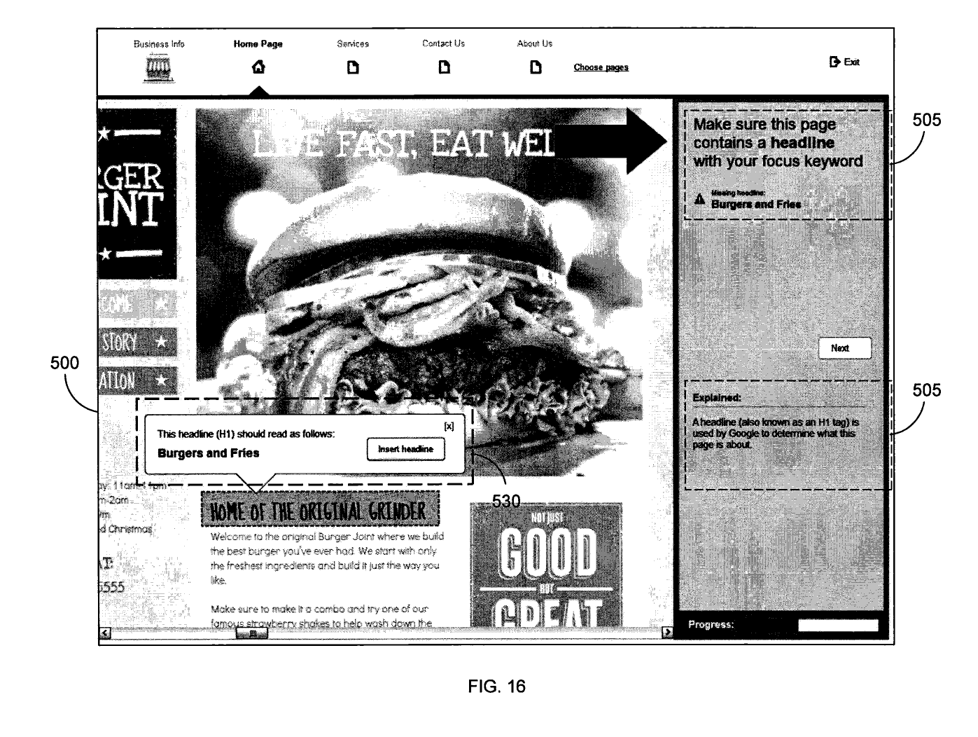

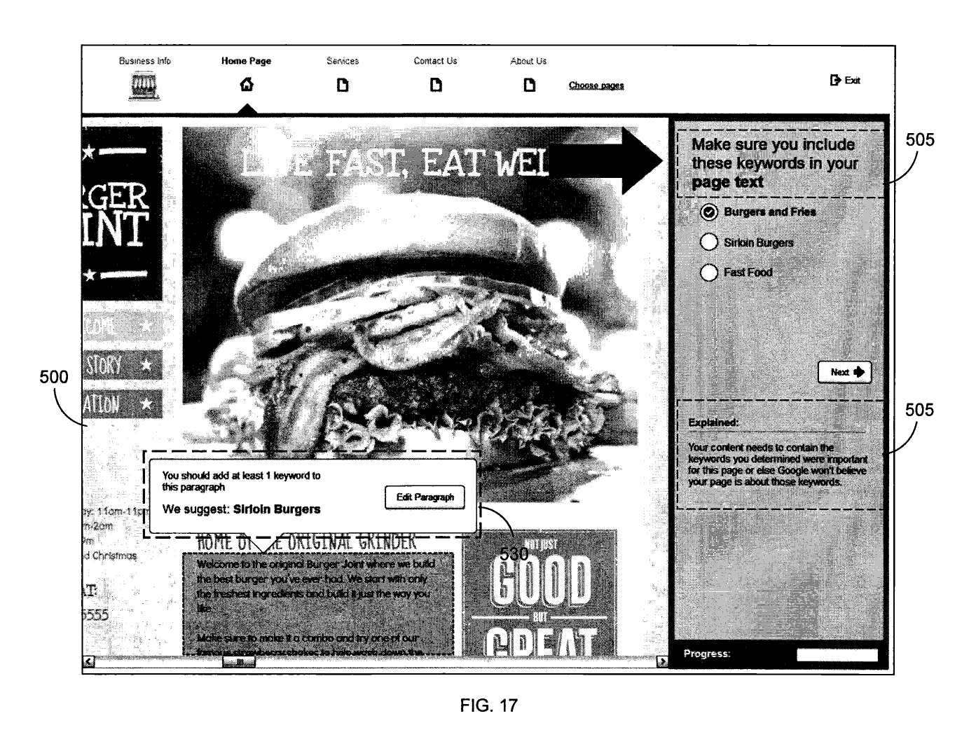

At step 435, the web server 100 may insert the selected keywords into the web page source code. In some embodiments, the insertion of keywords may be automated as described above with respect to step 230 of FIG. 2. In some embodiments, the keyword insertion may be partially or completely directed by user input, which may in turn be guided by educational displays 505. FIGS. 14-16 illustrate example interface screens where the web server 100 guides the user to incorporate the keywords into its web page source code. FIG. 14 illustrates the web server 100 guiding the user to set the text, including one or more of the selected keywords, that appears in the <title> HTML tag. FIG. 15 illustrates the web server 100 guiding the user to set the text of the <meta>“description” HTML tag, which appears in GOGGLE search results and should include the focus keyword for the web page. FIG. 16 illustrates the web server 100 guiding the user to include at least one headline, which is text within the <h1> HTML tag, that has the focus keyword in the headline. FIG. 17 illustrates the web server 100 guiding the user to include at least one keyword in text having a <p> (paragraph) HTML tag to confirm the subject matter of the web page. FIGS. 16 and 17 include an example interactive educational display 530, which may include a content suggestion and may further include a button or hyperlink that the user may click to instruct the web server 100 to automatically make the suggested change.

At step 440, the web server 100 may display interface screens for repeating the steps of keyword refinement, focus keyword selection, and keyword insertion for the other web pages of the website. At step 445, the web server 100 may collect and present ranking reports for the selected keywords, as described above with respect to step 235 of FIG. 2.

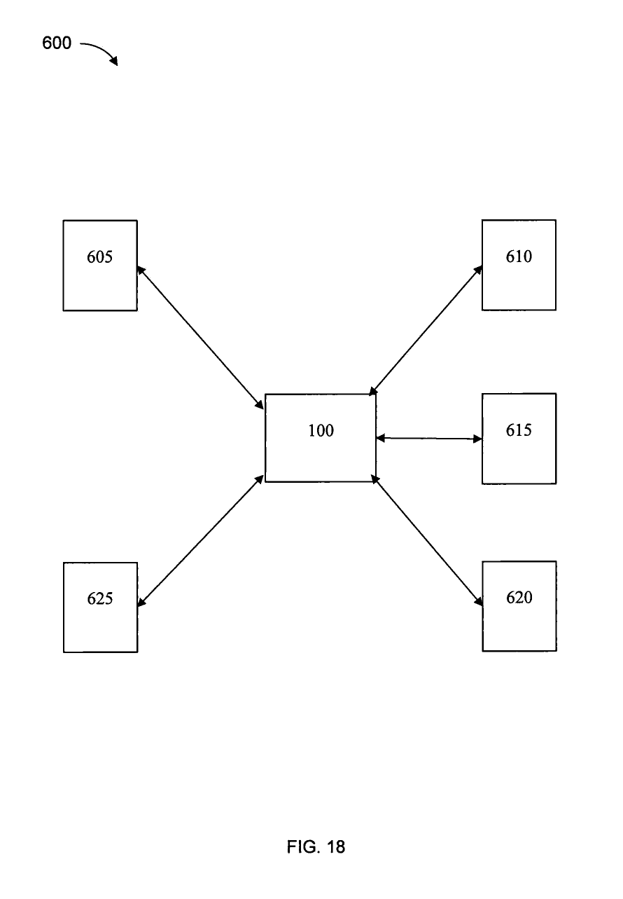

Referring to FIG. 18, a system 600 for performing the automated SEO optimization methods described above may include the web server 100 and a plurality of modules for performing one or more steps of the methods. The modules may be hardware or software-based processing modules located within the web server 100, in close physical vicinity to the web server 100, or remotely from the web server 100 and implemented as standalone computer servers or as components of one or more additional servers. The modules may include, without limitation: a user interface module 605 for providing input/output capabilities between the system 600 and the user; a data retrieval module 610 for performing Internet search engine searches and queries of data stores; a data processing module 615 for evaluating retrieved data and compiling, ordering, and formatting data for presentation; a website generation module 620, which may be a component of the data processing module 615 or a separate module, and which creates or modifies the website for which the SEO optimization methods are performed; and one or more data storage modules 625 for storing the data retrieved by the data retrieval module and the website being built or modified by the website generation module 820, and optionally further storing keyword sets and/or other websites, such as the competitors' websites.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention has been described in terms of one or more preferred embodiments, and it should be appreciated that many equivalents, alternatives, variations, and modifications, aside from those expressly stated, are possible and within the scope of the invention.

We claim:

1. A method, comprising:
obtaining, by at least one computer server, a set of keywords using a computer network, each keyword in the set of keywords being relevant to a business;
presenting to the user, by the at least one computer server, a first display containing a plurality of the keywords in the set of keywords and an interface with an option to refine the set of keywords on the first server;
receiving, by the at least one computer server, a refined set of keywords from the user; and
creating, by the at least one computer server, a website for the business; and
inserting, by the at least one computer server, keywords from the refined set of keywords into one or more web pages of the website.

2. The method of claim 1, wherein the set of keywords is obtained from a second server.

3. The method of claim 1, wherein obtaining the set of keywords comprises visiting each web page of one or more local competitor websites and scraping the keywords from the web pages of the local competitor websites.

4. The method of claim 1, wherein the first display further contains one or more educational displays regarding efficient keyword selection.

5. The method of claim 1, wherein inserting the keywords into the one or more web pages comprises generating HTML elements that contain the keywords.

6. The method of claim 1, further comprising:
retrieving, by the at least one computer server from one or more first data stores, analytical data for each keyword in the set of keywords; and
displaying the analytical data for each keyword in the first display.

7. The method of claim 6, wherein retrieving the analytical data comprises communicating with an analytical interface having access to the one or more first data stores.

8. The method of claim 7, wherein communicating with the analytical interface comprises querying the analytical interface for analytical data for each keyword, and receiving the analytical data from the analytical interface.

9. The method of claim 8, wherein the analytical data comprises traffic data stored in the first data stores.

10. The method of claim 6, further comprising:
retrieving, by the at least one computer server from one or more second data stores, competitive use data for each keyword in the set; and
presenting to the user a second display containing the keywords in the set, the competitive data associated with each keyword, and an option to remove unwanted keywords from the set.

11. The method of claim 10, wherein the competitive use data comprises a total number of competitors using each keyword on the competitor's website.

12. The method of claim 11, wherein the competitive use data further comprises one or more additional SEO metrics.

13. The method of claim 1, wherein the option to refine the set of keywords comprises an iterative process of presenting a subset of the keywords in the first display and replacing a removed keyword with a keyword from the set of keywords that is not in the subset.

14. The method of claim 1, further comprising: with the interface, prompting the user to choose one of the keywords in the set as a focus keyword.

15. A system, comprising a server in electronic communication with the Internet, with a user, and with one or more data stores, the server being configured to create a website for the user by:
obtaining a set of one or more keywords by:
visiting one or more local competitor websites;
identifying, from keywords being used on each of the local competitors websites, one or more potentially relevant keywords for the user; and
compiling the set of keywords from the potentially relevant keywords;
retrieving analytical data for each keyword in the set from one or more of the data stores;
presenting to the user a display and an interface that together enable the user to review the set and the analytical data and increase or decrease the number of keywords in the set; and
inserting the keywords from the set into one or more web pages of the website.

16. The system of claim 15, wherein the server is in electronic communication with the one or more data stores through an analytical interface, and wherein retrieving the analytical data for each keyword comprises querying the analytical interface for the analytical data, and receiving the analytical data from the analytical interface.

17. The system of claim 16, wherein the analytical data comprises traffic data.

18. The system of claim 16, wherein retrieving the analytical data for each keyword further comprises providing GPS data for the user to the analytical interface.

19. The system of claim 15, wherein inserting the keywords into the one or more web pages comprises generating HTML elements that contain the keywords and inserting the HTML elements into source code for the web pages.

20. The system of claim 15, further comprising:
retrieving competitive use data for each keyword in the set from one or more of the data stores; and
providing to the user an option to remove keywords from the set based on the competitive use data.
